(19) United States
(12) Patent Application Publication
(10) Pub. No.: US 2007/0256537 A1
(43) Pub. Date: Nov. 8, 2007

(54) Compact, multiple percussion practice pad apparatus

(76) Inventor: Daniel de los Reyes, Las Vegas, NV (US)

Correspondence Address: WILLIAM W. HAEFLIGER, 201 S. LAKE AVE, SUITE 512, PASADENA, CA, 91101, US

(21) Appl. No.: 11/409,692

(22) Filed: Apr. 25, 2006

(51) Int. Cl. G10D 13/02

(52) U.S. Cl. 84/421

(57) ABSTRACT

A percussion practice pad assembly, comprising a support, multiple pads carried by the support to be selectively struck, the pads characterized as producing different sounds, when struck, as during practice.

### BACKGROUND OF THE INVENTION

This invention relates generally to percussion practice equipment, and more particularly to different drum practice pads embodied in one portable apparatus.

There is need for versatile, efficient, portable, compact percussion practice equipment, wherein multiple pads are provided; and there is need for such equipment wherein the pads and associated support means are located in close relationship, as in a compact reversible portable device, the pads characterized as producing different low level sounds, when struck as by drumsticks or user's fingers. There is also need for a cowbell type or shaped device integrated into the equipment, and which also produces a low sound level when impacted by a drum stick or fingers.

### SUMMARY OF THE INVENTION

It is a major object of the invention to provide compact, versatile equipment, meeting the above need. As will be seen, the improved equipment basically comprising

a) a support,

b) multiple pads carried by the support to be selectively struck,

c) the pads characterized as producing different sounds, when struck as during practice,

d) at least one pad configured to be struck by a stick or sticks,

e) at least one other pad configured to be struck manually, by the drummer.

It is another object to locate certain pads to be exposed for impact, at opposite sides of a support, which is reversible. Such pads may for example to characterized as:
a) a snare pad
b) a Conga pad
   wherein the snare pad may consist of
x₁) a first elastomer,
x₂) a second elastomer offset from the first elastomer,
   the elastomers characterized as producing different low amplitude level sounds, when struck. These pads may extend in close edge-to-edge relation, for compactness.

Another object is to provide a support in the form of a shell having through openings acting to attenuate sound produced when either pad is struck.

A yet further object is to provide an auxiliary percussion impact surface, and positioner structure carried by said support for positioning that surface in offset relation to the pads. That impact surface may consist of an elastomer, such as rubber, and may have cowbell outline or outlines.

An added object is to provide pads at opposite sides of a support shell, and consisting of elastomers, such as different rubbers having different shore hardnesses.

Another object is to provide a support shell for the different pads, the shell defining through openings, for sound attenuation.

A further object is to configure the auxiliary device defining the cowbell to be removable, and to include a pad support defining through openings.

These and other objects and advantages of the invention, as well as the details of an illustrative embodiment, will be more fully understood from the following specification and drawings, in which:

### DRAWING DESCRIPTION

FIG. 1 is a top plan view of one preferred form of apparatus embodying the invention;

FIG. 2 is a side elevation view taken on lines 2-2 of FIG. 1;

FIG. 2a is a view like FIG. 2, but with the apparatus inverted;

FIG. 3 is a bottom plan view taken on lines 3-3 of FIG. 2;

FIG. 4 is a section taken on lines 4-4 of FIG. 1;

FIG. 5 is a fragmentary view taken on lines 5-5 of FIG. 2;

FIG. 6 is a section taken on lines 6-6 of FIG. 1, showing a cowbell device;

FIG. 7 is a bottom plan view taken on lines 7-7 of FIG. 6;

FIG. 8 is a section taken in elevation on lines 8-8 of FIG. 7; and

FIG. 9 is a section taken in elevation on lines 9-9 of FIG. 7.

### DETAILED DESCRIPTION

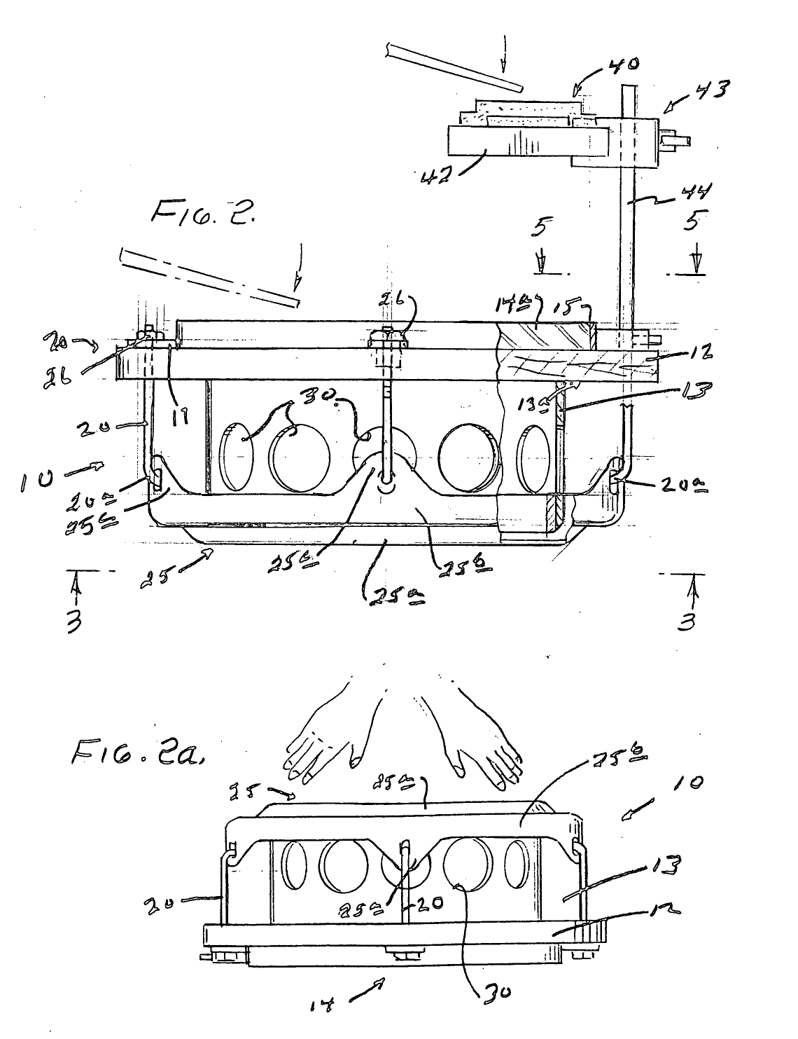

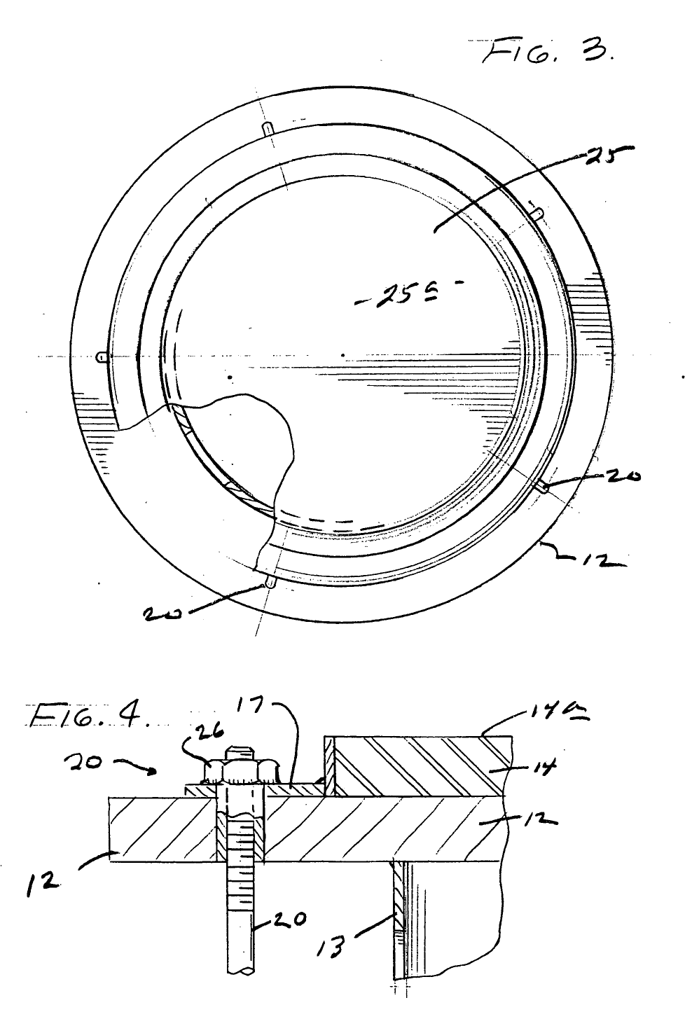

In the drawings, a percussion practice pad assembly 10 includes a support, and multiple pads carried by that support to be selectively struck, as by drumsticks 11 (see FIG. 2). The pads are characterized as producing different sounds, when struck, so that the drummer can instantly vary the audible output of the assembly as during practice drumming.

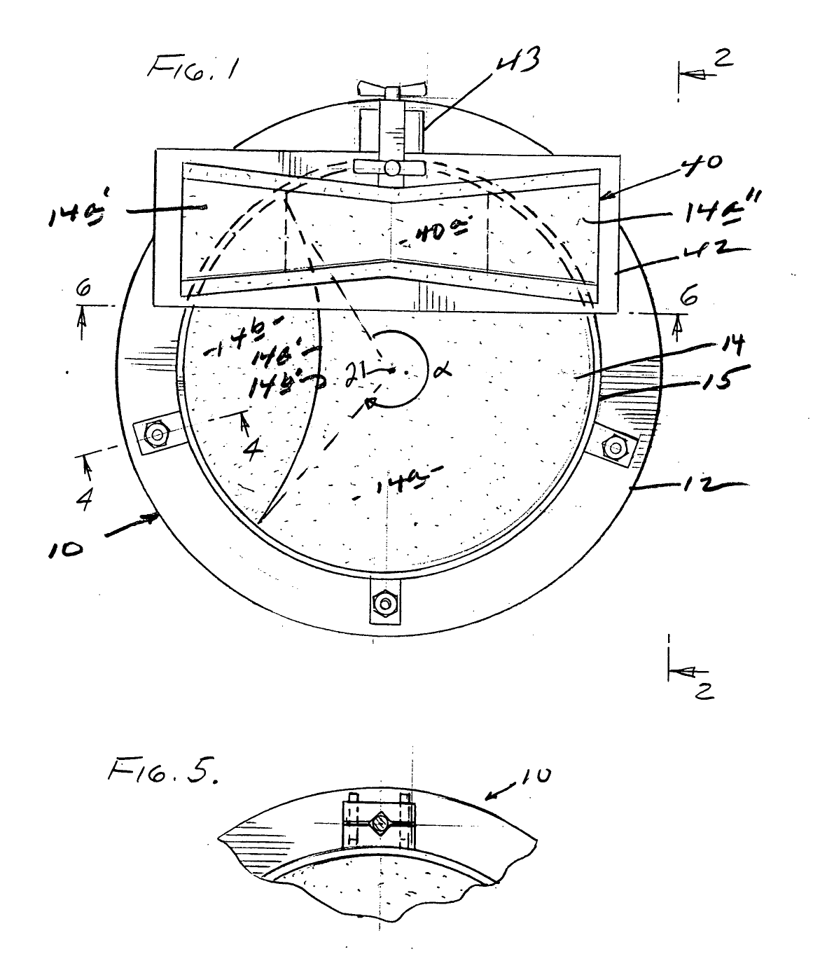

The illustrated support includes a base plate 12, to which a cylindrical shell 13 is attached as at 13a; and these elements may for example typically consist of wood. A “snare” pad 14 is carried by the base plate 12, and is surrounded by a metallic ring 15 attached to the plate. The pad may consist of a first elastomeric material, one example being rubber of a first selected shore value. An annular flange 17 on the ring may be attached to base plate 12, as by a fastener 20. In FIG. 1 and FIG. 2, the pad 14 has an upwardly exposed upper surface 14a that peripherally subtends an angle a, which is between 180° and 270°, about center or axis 21.

The pad 14 may include a second elastomer material with an upper surface 14b; and that material may also consist of rubber of a second selected shore value, so that when surface 14b is struck by a drumstick, the produced sound audibly differs from the sound produced when surface 14a is struck.

The edges 14b′ of surface 14b, and 14a′ of 14a, are typically located in close proximity as shown, and may be arcuate, whereby the total surface extent of 14a and 14b is circular in area, as in the case of a circular drum. Also, the pad thicknesses under 14a and 14b may differ, to add to the sound differentiation. As referred to, the pad 14 is supported by the underlying plate 12.

Upon inverting the unit, another practice pad 25 is exposed, having a beating surface 25a. That pad may be a Conga practice pad, and have a down turned annular periphery 25b with circularly spaced extensions 25c retained by hooks 20a on the fasteners 20. Nuts 26 at the opposite ends of the fasteners may be tightened to retain the extensions 25a, in place as seen in FIG. 2, we well as retaining flange 17 in place downwardly against the base plate. The pad 25 may also consist of elastomeric material, or of conventional Conga drum material, to be struck by the player's hand or fingers.

The cylindrical shell 13 is typically hollow, and may have through holes or openings 30 in its wall, to serve as outlets for sound produced by striking of the pads, some attenuation also being provided.

Referring back to FIGS. 1 and 2, and also to FIGS. 6-9, an auxiliary percussion impact surface is provided; and positioning structure is carried by the support for positioning that structure in offset relation to the described pad surfaces 14a, 14b and 25a. See for example auxiliary practice pad 40 with upper surface 40a in FIGS. 1 and 2, to be struck at intervals as when the player is optionally playing pad surface or surfaces 14a and 14b. Surface 40a includes two oppositely divergent playing surfaces 40a′ and 40a″ on the pad 40 supported on a wooden plate 42 clamped at 43 to a support rod 44. That rod is removably clamped at 45 to the base plate, spaced below the level of 42 and 43, whereby the elements 40-44 may be easily removed, when the apparatus is inverted to allow Conga drum practice. Surfaces 40a′ and 40a″ simulate two cowbells. Pad 40 may also consist of elastomeric material.

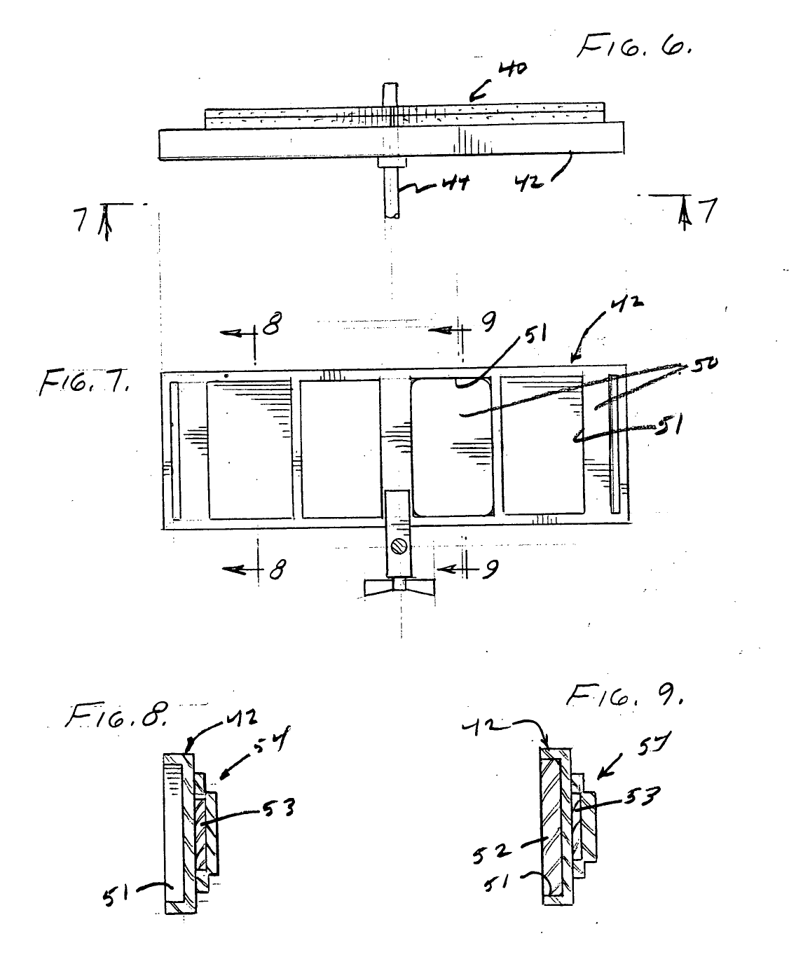

Wooden plate 42 may contain through openings as at 50; or filler (elastomer 52 for example) material some or all in openings 51, as seen in FIGS. 7, 8 and 9. See also filler 53 retained at 54.

I claim:

1. A percussion practice pad assembly, comprising, in combination
a) a support,
b) multiple pads carried by the support to be selectively struck,
c) the pads characterized as producing different sounds, when struck, as during practice,
d) at least one pad configured to be struck by a stick or sticks,
e) at least one other pad configured to be struck manually, by the drummer.

2. The combination of claim 1 wherein the pads are exposed at opposite sides of the support, which is portable, to be easily reversed.

3. The combination of claim 2 wherein the pads are characterized as:
d) a snare pad
e) a Conga pad.

4. The combination of claim 3 wherein the snare pad consists of an elastomer.

5. The combination of claim 4 wherein the snare pad consists of
x₁) a first elastomer,
x₂) a second elastomer offset from the first elastomer,
said elastomer characterized as producing different sounds when struck.

6. The combination of claim 5 wherein said elastomers have edge portions extending in mutual proximity.

7. The combination of claim 5 wherein said edge portions define an arc.

8. The combination of claim 1 wherein the pads consist of
x₁) a first elastomer,
x₂) a second elastomer offset from the first elastomer.

9. The combination of claim 8 wherein said elastomers have edge portions extending in mutual proximity.

10. The combination of claim 9 wherein said edge portions define an arc.

11. The combination of claim 2 wherein the support includes a shell, the shell having through openings acting to attenuate sound produced when either pad is struck.

12. The combination of claim 11 wherein the shell is generally tubular, and the openings are spaced about an interior zone defined by the shell, the pads located endwise of the shell.

13. The combination of claim 1 including an auxiliary percussion impact surface, and positioner structure carried by said support for positioning said surface in offset relation to the pads.

14. The combination of claim 13 wherein said impact surface consists of an elastomer.

15. The combination of claim 13 wherein said impact surface has a cowbell outline.

16. The combination of claim 13 wherein said impact surface has two cowbell outlines.

17. The combination of claim 14 wherein said impact surface has two cowbell outlines.

18. The combination of claim 13 wherein said impact surface consists of two relatively offset elastomers.

19. The combination of claim 18 wherein said elastomers are characterized as producing different sounds, when struck.

20. The combination of claim 19 wherein said two different elastomers have two different outlines.

21. The combination of claim 20 wherein said outlines have cowbell shape.

22. The combination of claim 1 wherein the pads consist of elastomers having different shore hardnesses.
